(19) United States
(12) Patent Application Publication
(10) Pub. No.: US 2014/0119346 A1
(43) Pub. Date: May 1, 2014

(54) APPARATUS AND METHOD FOR DETERMINING WHETHER A TRANSMITTER IS POWER LIMITED

(71) Applicant: Renesas Mobile Corporation, Tokyo (JP)

(72) Inventor: Michael WHITEHEAD, Farnham (GB)

(73) Assignee: Renesas Mobile Corporation, Tokyo (JP)

(21) Appl. No.: 14/066,047

(22) Filed: Oct. 29, 2013

(30) Foreign Application Priority Data
Oct. 31, 2012 (GB) 1219583.0

(51) Int. Cl. H04W 52/26

(52) U.S. Cl. CPC H04W 52/267
USPC 370/336; 370/329

(57) ABSTRACT

An apparatus and method of determining whether a transmitter is power limited. A predetermined number is added to an amount of useful data for transmission expressed in bits, thereby to calculate the size of an increased amount of useful data. The predetermined number corresponds to the minimum number of bits required to transmit additional user data and any associated header. A transmission format which has the smallest transport block size with capacity for the increased amount of useful data is then selected from a predetermined group of transmission formats. Each of the group of transmission formats has a different transport block size. It is then determined whether the power required for the transmitter to transmit the selected transmission format exceeds the maximum power available to the transmitter.

The apparatus and method can be applied to High Speed Uplink Packet Access (HSUPA) systems.

### TECHNICAL FIELD

The present invention relates to an apparatus and method for determining whether a transmitter is power limited.

### BACKGROUND

In a wireless communication system, a transmitter can be given one or more transmission allocations by a controller. The transmission allocations control how much data of particular types the transmitter can transmit. An example of a system implementing such transmission allocations is the High Speed Uplink Packet Access (HSUPA) system defined in 3GPP TS 25.321 Version 11.2.0 Release 11 (October 2012). In HSUPA a distinction is made between scheduled and non-scheduled data, each of which has its own transmission allocations. Non-scheduled data is typically used for essential purposes, such as signalling. Scheduled data is typically used for user data; a User Equipment (UE) is allocated a Serving Grant (SG) which determines the rate at which scheduled data is transmitted.

The SG is expressed in the terms of the power available for transmission. In a spread spectrum system, such as Wideband Code Division Multiple Access (WCDMA) and Universal Mobile Telecommunications System Frequency Division Duplexing (UMTS-FDD) used in HSUPA, the transmission power generally increases with the bit rate. Thus, a higher SG translates to a higher bit rate at which the UE can transmit data and so more scheduled data can be transmitted in a given time interval.

The SG is used, along with other relevant parameters, to select an Enhanced Dedicated Transport Channel Transport Format Combination (E-TFC). The E-TFC is selected from a group of possible E-TFCs (defined in 3GPP TS 25.321 Version 11.2.0 Appendix B), with each E-TFC supporting a different transport block size. During the selection of an E-TFC to be transmitted, the SG is converted into a number of bits and used together with other relevant parameters to select the amount of useful data, expressed as a number of bits, which can be transmitted. Useful data is data which has a purpose and use in the communication system, and in HSUPA is the transmitted MAC-e or MAC-i PDU. The selected E-TFC is the one with the smallest transport block size which will allow the transmission of the useful data.

In HSUPA, the UE indicates whether it could make use of a higher SG through an indication termed the “Happy Bit”. The Happy Bit indicates whether the UE is happy with the SG (i.e. no increase in SG desired) or unhappy with the SG (i.e. an increase in the SG is desired).

In order to determine the Happy Bit a number of considerations must be taken into account. Amongst these is whether the UE has sufficient power available to make use of a higher SG. If the UE is operating at its maximum power available, it cannot make use of a higher SG, because it does not have enough power available to transmit at the higher bit rate required by a larger SG, and so must conclude that it is power limited and not request any increase in SG.

In 3GPP TS 23.321 Version 11.2.0, the calculation of the Happy Bit is discussed in section 11.1.8.5. This defines a test for whether a UE has enough power available to transmit at a higher data rate. The test identifies the smallest E-TFC with a transport block size at least a predetermined number of bits larger than the transport block size of the E-TFC currently selected for transmission. The identified E-TFC is then checked for whether it is supported (i.e. not blocked). An E-TFC can be blocked as a result of a consideration of available power within the UE, for example by following the restriction procedure defined in 3GPP TS 25.133 V11.2.0 (September 2012), Annex A.6.6. As a result, this test considers whether there is sufficient power to support transmission of an E-TFC with a larger transport block size than the one currently selected.

### SUMMARY

In accordance with one exemplary embodiment of the present invention, there is provided an apparatus comprising a transmitter and a processor. The transmitter is configured to transmit an amount of useful data, which is based at least in part on a transmission allocation, within a current transmission format selected from a predetermined group of transmission formats, each of the group of transmission formats having a different transport block size. The processor is configured to determine whether the transmitter could use a higher transmission allocation without exceeding a maximum power available to the transmitter by:
adding a predetermined number to the amount of useful data expressed in bits, thereby to calculate the size of an increased amount of useful data, wherein the predetermined number corresponds to the minimum number of bits required to transmit additional data and any associated header;
selecting the transmission format from the group of transmission formats which has the smallest transport block size with capacity for the increased amount of useful data; and
determining whether the power required for the transmitter to transmit the selected transmission format exceeds the maximum power available to the transmitter.

In accordance with a further exemplary embodiment, there is provided a method of determining whether a transmitter is power limited. The method comprises:

adding a predetermined number to an amount of useful data for transmission expressed in bits, thereby to calculate the size of an increased amount of useful data, wherein the predetermined number corresponds to the minimum number of bits required to transmit additional data and any associated header;

selecting, from a predetermined group of transmission formats, a transmission format which has the smallest transport block size with capacity for the increased amount of useful data; wherein each of the group of transmission formats has a different transport block size; and

determining whether the power required for the transmitter to transmit the selected transmission format exceeds the maximum power available to the transmitter.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 shows a diagrammatic representation of a communications system.

FIG. 2 shows a diagrammatic representation of a radio interface protocol architecture;

FIG. 3 shows a diagrammatic representation of useful data and padding within a transport block; and

FIG. 4 depicts a flow chart for determining whether a transmitter is power limited according to an exemplary embodiment.

### DETAILED DESCRIPTION

“Wireless devices” include in general any device capable of connecting wirelessly to a network, and includes in particular mobile devices including mobile or cell phones (including so-called “smart phones”), personal digital assistants, pagers, tablet and laptop computers, content-consumption or generation devices (for music and/or video for example), data cards, USB dongles, etc., as well as fixed or more static devices, such as personal computers, game consoles and other generally static entertainment devices, various other domestic and non-domestic machines and devices, etc. The term “user equipment” or UE is often used to refer to wireless devices in general, and particularly mobile wireless devices.

The terms “transmitter” and “receiver” are also used herein and are to be construed broadly to include the whole of a device that is transmitting/receiving wireless signals as well as only particular components of a device that are concerned with transmitting/receiving wireless signals or causing or leading to the transmission/reception of wireless signals.

Reference will sometimes be made in this specification to “network”, “network control apparatus” and “base station”. In this respect, it will be understood that the “network control apparatus” is the overall apparatus that provides for general management and control of the network and connected devices. Such apparatus may in practice be constituted by several discrete pieces of equipment. As a particular example in the context of UMTS (Universal Mobile Telecommunications System), the network control apparatus may be constituted by for example a so-called Radio Network Controller operating in conjunction with one or more Node Bs (which, in many respects, can be regarded as “base stations”). As another example, LTE (Long Term Evolution) makes use of a so-called evolved Node B (eNB) where the RF transceiver and resource management/control functions are combined into a single entity. The term “base station” is used in this specification to include a “traditional” base station, a Node B, an evolved Node B (eNB), or any other access point to a network, unless the context requires otherwise. Moreover for convenience and by convention, the terms “network”, “network control apparatus” and “base station” will often be used interchangeably, depending on the context.

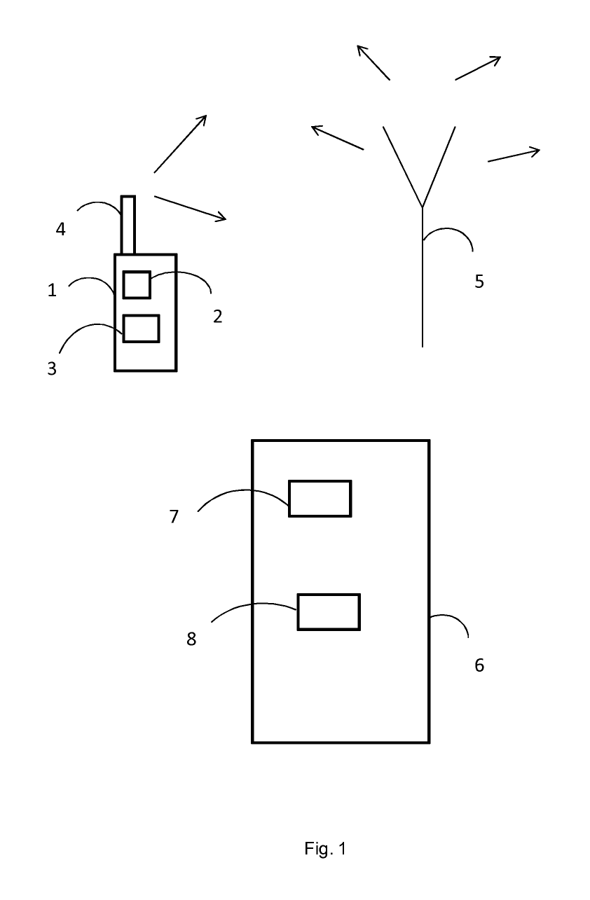

FIG. 1 depicts a diagrammatic representation of a communications system in which embodiments of the invention may be used. FIG. 1 shows schematically a user equipment or wireless device, in this case in the form of a mobile phone/smartphone 1. The user equipment 1 contains the necessary radio module 2, processor(s) and memory/memories 3, antenna 4, etc. to enable wireless communication with the network. The user equipment 1 in use is in communication with a radio mast 5. As a particular example in the context of UMTS (Universal Mobile Telecommunications System), there may be a network control apparatus 6 (which may be constituted by for example a so-called Radio Network Controller) operating in conjunction with one or more Node Bs (which, in many respects, can be regarded as “base stations”). As another example, LTE (Long Term Evolution) makes use of a so-called evolved Node B (eNB) where the RF transceiver and resource management/control functions are combined into a single entity. The term “base station” is used in this specification to include a “traditional” base station, a Node B, an evolved Node B (eNB), or any other access point to a network, unless the context requires otherwise. The network control apparatus 6 (of whatever type) may have its own processor(s) 7 and memory/memories 8, etc.

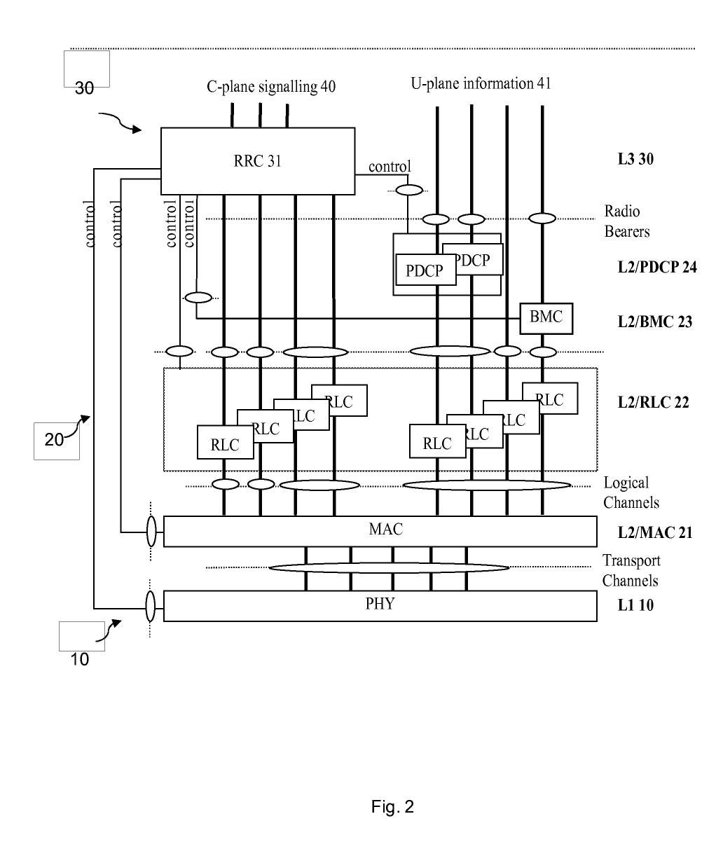

FIG. 2 shows schematically an example of the radio interface protocol architecture applicable for a UE 1 in for example UMTS and E-UTRAN. A similar “layer” architecture is used in other wireless systems. In overview and in general terms, there is a physical layer L1 10, a data link layer L2 20 and a network layer L3 30. The physical layer L1 10 offers information transfer services to MAC and higher layers and defines the relationship between the UE 1 and the wireless transmission medium. The data link layer L2 20 is split into following sublayers: Medium Access Control (MAC) 21, Radio Link Control (RLC) 22, Packet Data Convergence Protocol (PDCP) 23 and Broadcast/Multicast Control (BMC) 24. The network layer L3 and the RLC 22 are divided into a Control (C-) plane 40 (which in essence deals with control signals) and a User (U-) plane 41 (which in essence deals with user-generated data traffic). In the C-plane 40, the network layer L3 30 is partitioned into sublayers where the lowest sublayer, denoted as Radio Resource Control (RRC) 31, interfaces with the data link layer L2 20 and ultimately terminates in the radio access network.

In some transmission methods, the transmission of data by the UE is controlled by a transmission allocation, sometimes known as a “grant”. The transmission allocation is used to determine how much data a UE can transmit in a given time period. For example, in HSUPA, as defined by 3GPP TS 25.321 V11.2.0 which is incorporated herein by reference, the transmission of data from the UE to the base station can be in the form of scheduled or non-scheduled data. Scheduled data is used for the majority of user data and the amount of scheduled data in a transmission is limited by the Serving Grant (SG) allocated to the UE. It is desirable for the UE to be able to send an indication to the network to indicate whether or not it can make use of an increased transmission allocation. For example, in HSUPA, the UE sends a “Happy Bit” which indicates whether or not it could make use of an increased SG. In order to determine the Happy Bit, the UE considers various factors, all of which must be satisfied for the Happy Bit to be set to an “unhappy” value indicating that the UE could make use of an increased SG.

One criteria when determining the Happy Bit is whether the UE has enough power available to transmit more data, which can be considered as testing whether the UE is power limited. Transmission of more data within the same time period will generally involve increased power. Embodiments of the invention provide an apparatus and method which can determine whether a UE is power limited.

Wireless communication systems can make use of predefined transmission formats for communication between the UE and the base station. The use of such transmission formats allows transmission at different bit rates (and thus different transmission powers in a spread spectrum modulation system) to take place. A set of transmission formats is defined, each with a different transmission block size. This can simplify implementation but means that very fine control over bit rate is not possible. For example, in HSUPA Annex B of 3GPP TS 25.321 defines different groups of transmission formats (E-TFC) for different network configurations. Table 1 below sets out the first six Transport Block Sizes defined in Annex B2 of 3GPP TS 25.321 for a 2 ms Transmission Time Interval (TTI). Each is referenced by an E-TFC Index (E-TFCI).

TABLE 1
Example Transport Block Sizes

| E-TFCI | Transport Block Size in Bits |
|---|---|
| 0 | 18 |
| 1 | 186 |
| 2 | 204 |
| 3 | 354 |
| 4 | 372 |
| 5 | 522 |

Table 1 shows how the change in transport block sizes from one E-TFCI to the next is variable and can be large (for example 150 bits between E-TFCI=2 and E-TFCI=3) or small (for example 18 bits between E-TFCI=1 and E-TFCI=2).

It is unlikely that the amount of data to be transmitted will map exactly to one of the transmission formats. For example, in HSUPA a given SG is unlikely to result in a number of bits which exactly matches the transport block size of an E-TFC. Even if it did, it is possible that the amount of useful data for transmission will still not exactly match the number of bits calculated from the SG. Other factors will also influence the amount of useful data transmitted and hence the choice of an E-TFC. For example, in HSUPA there may also be non-scheduled data to transmit, which is not limited by the SG. In that case the amount of useful data transmitted may be greater than the number of bits resulting from the SG alone. It is also possible that the UE may not have enough data for transmission to make full use of the SG, so that a smaller amount of data than the SG may be transmitted. As a result, the UE selects the E-TFC with the smallest block size suitable for the amount of useful data to be transmitted when expressed as a number of bits. Useful data is data which has a purpose in the communication system, it can include headers and payload data and, in the case of HSUPA, include both scheduled and non-scheduled data.

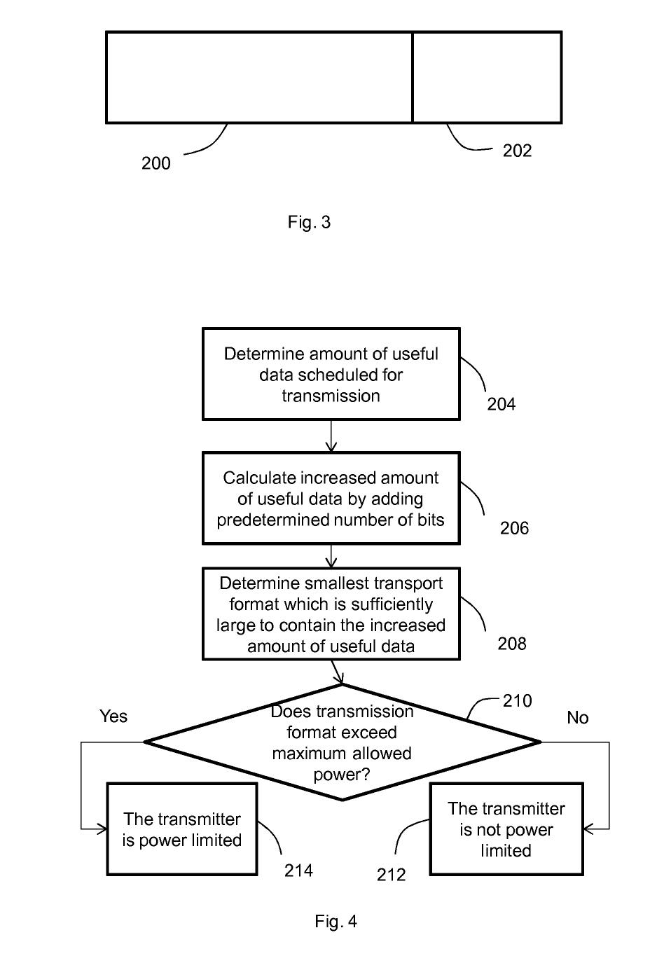

For example, in HSUPA, if a particular SG limits the amount of scheduled useful data to 210 bits and the UE has sufficient scheduled data available to make use of the whole SG then the UE will select E-TFCI=3 when there is no non-scheduled data for transmission. Any space in the selected E-TFCI which is above the number of bits of useful data (which is calculated at least in part from the SG) is filled with padding. FIG. 3 depicts a graphical representation of this situation; the transport block is filled with 210 bits of useful data 200 and 144 bits of padding 202. The UE is prevented from transmitting more than 210 bits of scheduled useful data by the SG.

Exemplary embodiments provide a method and apparatus in which the UE can determine whether it is power limited, taking into consideration the presence of padding in transmitted data. Padding is not useful data and serves no purpose in the communication system other than to ensure the number of bits transmitted matches the transport block size of the selected transmission format. The processor in the UE can be configured by instructions in the memory to determine an increase in the amount of useful data, expressed as a number of bits, by adding a predetermined number which corresponds to the minimum number of bits required to transmit some additional user data and any associated header. This gives a value for an increased amount of useful data which is then used to select a transmission format which is sufficiently large to contain this increased amount of useful data. The selected transmission format is then tested to see if transmitting it would exceed the maximum power available to the UE. For example, a check can be made whether the selected transmission format is blocked because it exceeds the maximum power available to the transmitter. Alternatively, the power required for the selected transmission format can be calculated and compared to the maximum power available to the transmitter.

A feature of the exemplary embodiment is that it uses the amount of useful data scheduled to be transmitted expressed as a number of bits, not the transport block size of the currently selected transmission format. It will therefore take into account under-use of the currently selected transmission format. For example, the increased amount of useful data may still fit within the transport block size of the currently selected transmission format, meaning that there is no change to the transmission format and enabling the UE to conclude that it is not power limited (because it would require no change in the transmission format), whereas it may not have enough power available for the transmission format with the next largest transport block size, particularly when the gap is larger, for example as shown in Table 1 above between E-TFCI=4 and E-TFCI=5.

In some embodiments, the predetermined number is a fixed number of bits, for example 8, 16, 32 or 64 bits, other numbers of bits can also be used. In other embodiments the predetermined number is the smallest number of bits required to transmit for example, a Radio Link Control Protocol Data Unit.

The processor can be further configured to cause the transmitter to transmit an indication whether a higher transmission allocation could be used, wherein the indication is dependent at least in part upon the determination whether the transmitter could use a higher transmission allocation without exceeding a maximum power.

Embodiments of the invention can be applied to a HSUPA system. For example, the UE can be configured for use in a HSUPA system.

In embodiments which are applied to HSUPA systems, the transmission allocation can be the Serving Grant. The transmission format is an Enhanced Transport Format Combination (E-TFC)

The UE can be configured to operate in MAC-i/is mode in HSUPA. In MAC-i/is is mode the amount of useful data is equal to the size of the transmitted MAC-i PDU. In MAC-i/is mode the predetermined number is chosen as 32 bits, which represents the minimum increase to send additional user data including 24 bits for the header and 8 bits of user data. (In MAC-i/is mode the additional user data can be a segment of a Radio Link Control PDU, the smallest such segment size being 8 bits). In other systems different predetermined numbers can be used depending on the minimum amount required to send additional user data.

The UE can also be configured to not operate in a MAC-i/is mode in HSUPA, for example it can operate in a MAC-e/es mode. In that case the amount of useful data, is equal to the size of the transmitted MAC-e PDU. The predetermined number is the size of the smallest configured Radio Link Control PDU (RLC PDU), which represents the minimum increase required to send further data.

In embodiments where an indication is transmitted, when applied to HSUPA systems, the indication is a Happy Bit, and the Protocol Data Unit whose size was used to calculate the increased amount of useful data is transmitted in the same Transmission Time Interval as the Happy Bit.

One specific numerical example of an embodiment will now be described with reference to the transmission formats defined in HSUPA. However, the invention is not limited to HSUPA and can be applied to other systems in which it is desired to determine whether a transmitter is power limited.

The UE 1 is configured to use a MAC-i header type and 2 ms TTI. The applicable E-TFC transmission block sizes are as defined above in Table 1. (Table 1 was taken from 3GPP TS 25.321 Annex B.2). Signalling radio bearers are mapped onto a non-scheduled flow which is configured with a non-scheduled grant of 168 bits. User radio bearer is mapped onto a scheduled flow and so cannot exceed the number of bits derived from the Serving Grant.

The UE has carried out a restriction procedure with reference to its internal power budget and determined that the maximum E-TFCI allowed without exceeding available HSUPA power is E-TFCI=3: 354 bits. Thus, the UE has established that all E-TFCIs which are greater than 3 are blocked. Suitable restriction procedures are known to the skilled person, for example blocking all E-TFCIs with a transport block size larger than the number of bits equating to the maximum transmission power. Alternatively, the UE may carry out the restriction procedure defined in 3GPP TS 25.133 V11.2.0 (September 2012), Annex A.6.6, incorporated herein by reference.

The UE has a large amount of scheduled data available for sending, and has no unscheduled data available for sending, so all the data to be transmitted comprises scheduled data.

The UE's current Serving grant equates to 210 bits. Thus. E-TFCI=3 is selected, the maximum E-TFCI which the power available allows. In the first transmission the transport block size of 354 bits contains a MAC-i PDU of 210 bits (this is useful data) and 144 bits of padding (as depicted in FIG. 3).

When determining whether to send an “unhappy” Happy Bit, indicating that the Serving Grant could be increased, the processor of the UE adds 32 bits onto the MAC-i PDU size to give an increased amount of useful data of 242 bits. The UE then tests E-TFCI=3 again to determine whether there is enough power for the increased amount of useful data, because this is the smallest E-TFCI which has a transport block size sufficient to transmit the increased transmission allocation. The processor of the UE can then conclude that this does not exceed the maximum power available because E-TFCI=3 is not blocked. Providing any other conditions are also met, the processor can cause the transmitter to transmit an “unhappy” Happy Bit and request a larger serving grant.

On receiving an “unhappy” Happy Bit, the network may increase the serving grant. For example, if network increases serving grant so that it equates to 375 bits, then for subsequent transmissions, the UE will still transmit ETFCI=3, (because higher E-TFCIs are blocked due to the restriction procedure) but now the transport block size of 354 bits can be fully used and will contain a MAC-i PDU of 354 bits (this is useful data) and no padding.

The power limitation test method defined in 3GPP 25.321, section 11.1.8.5 will now be compared with that of the exemplary embodiment described above. At the beginning, both methods operate in the same way. The UE transmits ETFCI=3. The transport block size of 354 bits contains a MAC-i PDU of 210 bits (this is useful data) and 144 bits of padding. However, unlike the exemplary embodiment, the UE must conclude that it is power limited and cannot transmit an “unhappy” Happy Bit to request an increased serving grant as will be explained below.

For operation in MAC-i mode the processor adds 32 bits to the transport block size of the currently selected E-TFCI, following the procedure in 3GPP TS25.321 11.1.8.5. This results in a value of 386 bits which requires use of ETFCI=5 (see Table 1 above). However, E-TFCI=5 is blocked because it causes the available power limit to be exceeded. The processor must conclude that the transmitter is power limited and cause a “happy” Happy Bit to be transmitted, despite the fact that there are 144 bits of padding which could be used for useful data without needing to increase the transmitted power. On receiving a “happy” Happy Bit from the UE, the network will not increase the serving grant and so all forthcoming transmissions will be the same: a MAC-i PDU of 210 bits (this is payload data) and 144 bits padding.

The above example illustrates the potential benefits of the invention. With the method of testing whether a transmitter is power limited defined in 3GPP TS 25.321 11.1.8.5, the UE is stuck with a serving grant equating to 210 payload bits per transmission, even though it is using an E-TFC with a transport block size of 354 bits and so it could increase its use of the currently selected E-TFC without increasing transmission power. With the exemplary embodiment of the invention, after the network has increased the serving grant (due to unhappy reports), the UE can send 354 bits of useful data per transmission, making full use of the E-TFC, achieving a 68.5% increase in throughput over the method of 3GPP TS 25.321 section 11.1.8.5.

A further benefit of the invention is that it is fully compatible with existing protocols on the network side. It therefore can be implemented in the UE without requiring a corresponding upgrade to other portions of the network. For example, when applied to HSUPA, only the UE operation is altered, not the network. The invention can therefore be implemented as a UE feature without requiring a network upgrade.

FIG. 4 depicts a flow chart of an exemplary embodiment for determining whether a transmitter is power limited according to the present invention. First, at step 204, the amount of useful data scheduled for transmission is expressed as a number of bits. For example, when applied to HSUPA, the amount of useful data is the size of the MAC-i or MAC-e PDU scheduled for transmission. Next, at step 206, the amount of useful data is increased by a predetermined number of bits corresponding to the minimum number of bits required to transmit additional user data and any associated header. For example, when applied to HSUPA in a MAC-i/is mode, the predetermined number can be 32 bits. Then, at step 208, the increased amount of useful data is used to select to a corresponding transmission format. For example, when applied to HSUPA, the transmission format is the E-TFC with the smallest transport block size that can accommodate the increased amount of useful data. The transmission format is then tested to see if it exceeds the maximum power available to the transmitter at step 210. If it does not exceed the maximum power, it is concluded in step 212 that the transmitter is not power limited. If it does exceed the maximum power, it is concluded in step 214 that the transmitter is power limited.

Although at least some aspects of the embodiments described herein with reference to the drawings comprise computer processes performed in processing systems or processors, the invention also extends to computer programs, particularly computer programs on or in a carrier, adapted for putting the invention into practice. The program may be in the form of non-transitory source code, object code, a code intermediate source and object code such as in partially compiled form, or in any other non-transitory form suitable for use in the implementation of processes according to the invention. The carrier may be any entity or device capable of carrying the program. For example, the carrier may comprise a storage medium, such as a solid-state drive (SSD) or other semiconductor-based RAM; a ROM, for example a CD ROM or a semiconductor ROM; a magnetic recording medium, for example a floppy disk or hard disk; optical memory devices in general; etc.

It will be understood that the processor or processing system or circuitry referred to herein may in practice be provided by a single chip or integrated circuit or plural chips or integrated circuits, optionally provided as a chipset, an application-specific integrated circuit (ASIC), field-programmable gate array (FPGA), digital signal processor (DSP), etc. The chip or chips may comprise circuitry (as well as possibly firmware) for embodying at least one or more of a data processor or processors, a digital signal processor or processors, baseband circuitry and radio frequency circuitry, which are configurable so as to operate in accordance with the exemplary embodiments. In this regard, the exemplary embodiments may be implemented at least in part by computer software stored in (non-transitory) memory and executable by the processor, or by hardware, or by a combination of tangibly stored software and hardware (and tangibly stored firmware).

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

We claim:

1. An apparatus comprising:
a transmitter configured to transmit an amount of useful data, which is based at least in part on a transmission allocation, within a current transmission format selected from a predetermined group of transmission formats, each of the group of transmission formats having a different transport block size; and
a processor configured to determine whether the transmitter could use a higher transmission allocation without exceeding a maximum power available to the transmitter by:
adding a predetermined number to the amount of useful data expressed in bits, thereby to calculate the size of an increased amount of useful data, wherein the predetermined number corresponds to a minimum number of bits required to transmit additional user data and any associated header;
selecting the transmission format from the group of transmission formats which has the smallest transport block size with capacity for the increased amount of useful data; and
determining whether the power required for the transmitter to transmit the selected transmission format exceeds the maximum power available to the transmitter.

2. The apparatus of claim 1, wherein the predetermined number is the smallest number of bits required to transmit a protocol data unit.

3. The apparatus of claim 1, wherein the processor is further configured to cause the transmitter to transmit an indication whether a higher transmission allocation could be used, wherein the indication is dependent at least in part upon the determination whether the transmitter could use a higher transmission allocation without exceeding a maximum power.

4. The apparatus of claim 3, wherein the apparatus is configured to operate in a High Speed Uplink Packet Access system.

5. The apparatus of claim 4, wherein the apparatus is configured to operate in MAC-i/is mode, the amount of useful data is a MAC-i Protocol Data Unit selected for transmission.

6. The apparatus of claim 5, wherein the predetermined number is 32 bits.

7. The apparatus of claim 4, wherein the apparatus is not configured to operate in a MAC-i/is mode, the amount of useful data is a MAC-e Protocol Data Unit selected for transmission.

8. The apparatus of claim 7, wherein the predetermined number is the size of the smallest configured Radio Link Control Protocol Data Unit.

9. The apparatus of claim 4, wherein the transmission allocation is a Serving Grant

10. The apparatus of claim 4, wherein the transmission format is an Enhanced Transport Format Combination.

11. The apparatus of claim 4, wherein the indication whether a higher transmission allocation could be used is a Happy Bit, and the Protocol Data Unit selected for transmission is selected for transmission in the same Transmission Time Interval as the Happy Bit.

12. The apparatus of claim 1, wherein the apparatus is a mobile device.

13. A method of determining whether a transmitter is power limited, the method comprising:
adding a predetermined number to an amount of useful data for transmission expressed in bits, thereby to calculate the size of an increased amount of useful data, wherein the predetermined number corresponds to a minimum number of bits required to transmit additional user data and any associated header;
selecting, from a predetermined group of transmission formats, a transmission format which has the smallest transport block size with capacity for the increased amount of useful data; wherein each of the group of transmission formats has a different transport block size; and
determining whether the power required for the transmitter to transmit the selected transmission format exceeds the maximum power available to the transmitter.

14. The method of claim 13, wherein the predetermined number is the smallest number of bits required to transmit a protocol data unit

15. The method of claim 13, further for transmitting an indication whether a transmission allocation could be increased, the method further comprising transmitting an indication which is dependent at least in part upon the determination whether the transmitter could use a higher transmission allocation without exceeding a maximum power.

16. The method of claim 15, wherein the indication is a Happy Bit in a High Speed Uplink Packet Access system.

17. The method of claim 16, wherein the amount of useful data is the size in bits of a MAC-i Protocol Data Unit selected for transmission in the same Transmission Time Interval as the Happy Bit.

18. The method of claim 17, wherein the predetermined number is 32 bits.

19. The method of claim 16, wherein the amount of useful data is the size in bits of a MAC-e Protocol Data Unit selected for transmission in the same Transmission Time Interval as the Happy Bit.

20. The method of claim 19, wherein the predetermined number is the size of the smallest configured Radio Link Control Protocol Data Unit.

21. The method of claim 16, wherein the transmission allocation is a Serving Grant.

22. The method of claim 16, wherein the transmission format is an Enhanced Transport Format Combination.
